(19) United States
(12) Patent Application Publication
(10) Pub. No.: US 2026/0157517 A1
(43) Pub. Date: Jun. 11, 2026

(54) FURNITURE ASSEMBLY AND CONSTRUCTION METHOD

(71) Applicant: Compass Rose Toolworks, LLC, Cleveland Heights, OH (US)

(72) Inventor: Rex Krueger, Cleveland Heights, OH (US)

(21) Appl. No.: 19/415,045

(22) Filed: Dec. 10, 2025

Related U.S. Application Data
(60) Provisional application No. 63/730,625, filed on Dec. 11, 2024.

(51) Int. Cl. A47B 13/08; A47B 13/02; B25H 1/00

(52) U.S. Cl. CPC A47B 13/08; A47B 13/021; B25H 1/00; A47B 2230/0074

(57) ABSTRACT

A furniture assembly includes a plurality of legs, a plurality of supports each configured to be coupled to at least two of the plurality of legs, and a top configured to be coupled to the plurality of legs, wherein each of the legs, the supports, and the top are formed from a plurality of pieces coupled together.

### RELATED APPLICATIONS

This application claims the benefit of U.S. Provisional Application No. 63/730,625 filed Dec. 11, 2024, which is hereby incorporated herein by reference.

### FIELD OF THE DISCLOSURE

The present application relates generally to a furniture assembly, and more particularly to a workbench and the construction of the workbench.

### BACKGROUND

Traditionally, packing, shipping, and assembling of hardwood furniture is inherently cumbersome due to its substantial weight, complex construction, and the care needed to preserve its structural integrity during transport and setup. Solid hardwood requires robust packaging to prevent damage during transit and often demands multiple people or specialized equipment for handling.

The method of constructing further contributes to these challenges. Furniture built with mortise-and-tenon joinery, known for its strength and durability, often needs to be preassembled to ensure precision and stability. Traditional mortise-and-tenon joints also typically require clamps to hold components securely in place while adhesive sets, adding time and effort during assembly. This process results in a solid, long-lasting piece, but it makes the furniture difficult to disassemble for compact shipping, necessitating the transportation of bulky, fully-constructed items. Alternatively, assembly of furniture that uses mechanical fasteners, such as bolts and screws, becomes labor-intensive, requiring precise alignment and the use of tools to ensure stability and balance.

### SUMMARY

The furniture assembly of the present application relates to a woodworking bench. The woodworking bench is constructed with a suitable material such as plywood, where pieces may be cut using a Computer Numerical Control (CNC) machine, assembled without the need for clamps, and may be flat-pack shipped.

According to an aspect, a furniture assembly is provided that includes a plurality of legs, a plurality of supports each configured to be coupled to at least two of the plurality of legs, and a top configured to be coupled to the plurality of legs, wherein each of the legs, the supports, and the top are formed from a plurality of pieces coupled together.

According to another aspect, a method of forming a furniture assembly, the method including cutting or perforating a sheet material to form a plurality of leg pieces, a plurality of support pieces, and a plurality of top pieces, forming a plurality of legs by laminating at least two of the plurality of leg pieces together for each leg, forming a plurality of supports by laminating at least two of the plurality of the support pieces together for each support, forming a top by laminating the plurality of top pieces together, and assembling the plurality of legs, plurality of supports, and the top together.

According to still another aspect, a flat-pack kit for constructing a workbench is provided. The kit includes a plurality of leg pieces, a plurality of support pieces, a plurality of top pieces, and a plurality of pegs, wherein each of the plurality of leg pieces, plurality of support pieces, and plurality of top pieces are cut from a sheet material and configured to be laminated to form, respectively, a plurality of legs, a plurality of supports, and a top, wherein the at least some of the plurality of support pieces include projections configured to form tenons receivable in mortises formed in the legs, and wherein the plurality of pegs are configured to be driven through offset holes in the legs and the supports to draw mortise-and-tenon joints together.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof.

FIG. 1 is a perspective view of an exemplary furniture assembly.

FIG. 2 is a top view of components of the furniture assembly.

FIG. 3A illustrates legs of the assembly in an exploded state.

FIG. 3B illustrates legs of the assembly in a constructed state.

FIG. 3C illustrates legs of the assembly in another exploded view.

FIG. 4 illustrates supports of the assembly in a constructed state.

FIG. 5A illustrates the construction of the legs and supports.

FIG. 5B is a close-up view of the legs and supports.

FIG. 5C is another close-up view of the legs and supports.

FIG. 5D also illustrates assembly of the legs and supports.

FIG. 6 illustrates assembly of a top to the legs.

FIG. 7A is a close-up view of the legs and top.

FIG. 7B illustrates assembly of a top to the legs.

FIG. 8 illustrates an assembled furniture assembly receiving pins.

FIG. 9A is a perspective view of a vice.

FIG. 9B is a close-up view of a vice attached to the furniture assembly.

FIG. 9C is a close-up view of a ratchet and lever attached to the furniture assembly.

FIG. 9D is another close-up view of a ratchet and lever attached to the furniture assembly.

FIG. 9E is another close-up view of a ratchet and lever attached to the furniture assembly.

FIG. 10A is a close-up view of a planning stop on an exemplary furniture assembly.

FIG. 10B is another close-up view of a planning stop on an exemplary furniture assembly.

FIG. 11 illustrates the components of the furniture assembly in a shipping state.

FIG. 12A is a perspective view of another exemplary furniture assembly.

FIG. 12B is an exploded view of a top of an exemplary furniture assembly.

FIG. 12C illustrates the construction of an exemplary furniture assembly.

FIG. 12D is a top view of components of an exemplary furniture assembly.

FIG. 12E illustrates the components of an exemplary furniture assembly in a shipping state.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

It may be appreciated that the principles of the present application describes construction of a furniture assembly 100, such as a French style woodworking bench, but it will be appreciated that the principles described may be applied to other woodworking designs, such as a Nicholsen workbench, an English joiner's bench, a Danish/Continental cabinet-maker's bench, a Moravian workbench, an English shavehorse, a Swedish or dumbhead shavehorse, a sawbench, a mortising stool, tables, desks, etc.

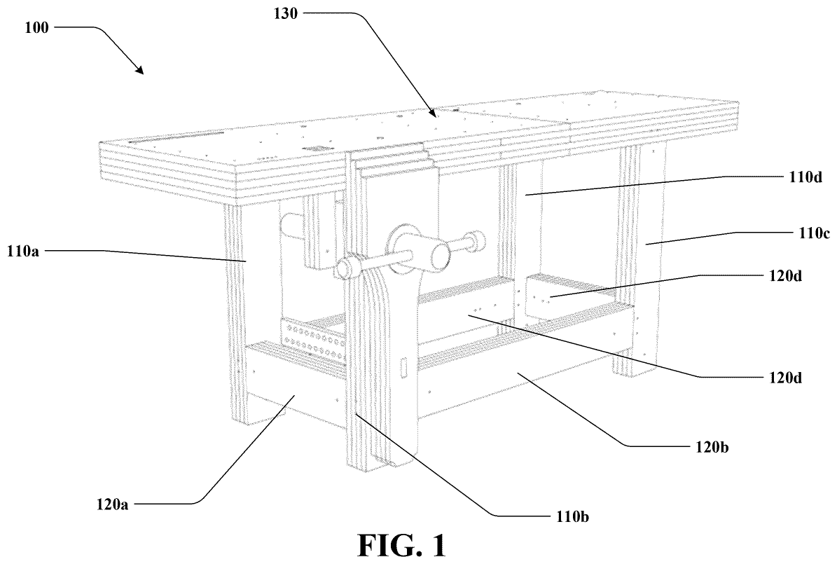

Turning to FIG. 1, an exemplary furniture assembly 100 is illustrated in a final constructed state. The furniture assembly 100 may include a plurality of legs 110, such as legs 110a-110d, a plurality of supports 120, such as supports 120a-120d coupled to the legs 110a-110d, and a top 130 coupled to the legs 110a-110d. The furniture assembly 100 may be formed by a plurality of pieces coupled together to form various parts of a workbench 100.

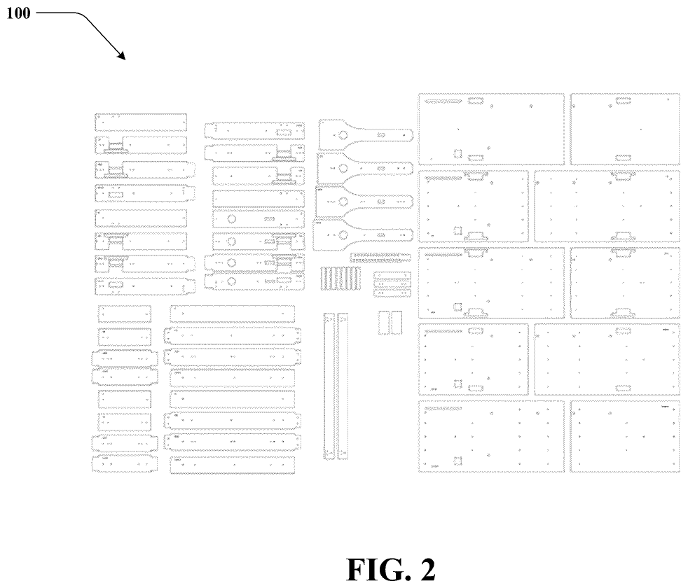

As illustrated in FIG. 2, the furniture assembly 100 is shown in an initial pre-construction state, where the various pieces that form the components of the furniture assembly are shown from above. The furniture assembly 100 may be a plywood construction or any other suitable material, may be formed from CNC manufacturing, may be a clamp-free assembly by the user, and is designed for flat-pack shipping. The furniture assembly 100 is made from multiple sheets of plywood, such as cabinet-grade plywood cut into components using a CNC router. Alternative materials such as fiberboard, particle board, sheet metal, plastic sheet, wood-plastic composite fiber-reinforced plastic, honeycomb core panels, fiber cement boards, or other suitable material may be used. Each component of the furniture assembly 100 is made by laminating together multiple pieces of material, building components, such as the legs, supports and top, up from layers. It will be appreciated that the materials and laminated construction make the furniture assembly 100 immune to atmospheric moisture and will not change shape like solid wood. The furniture assembly 100 will not need periodic flattening or resurfacing and will stay flat and square throughout its working life.

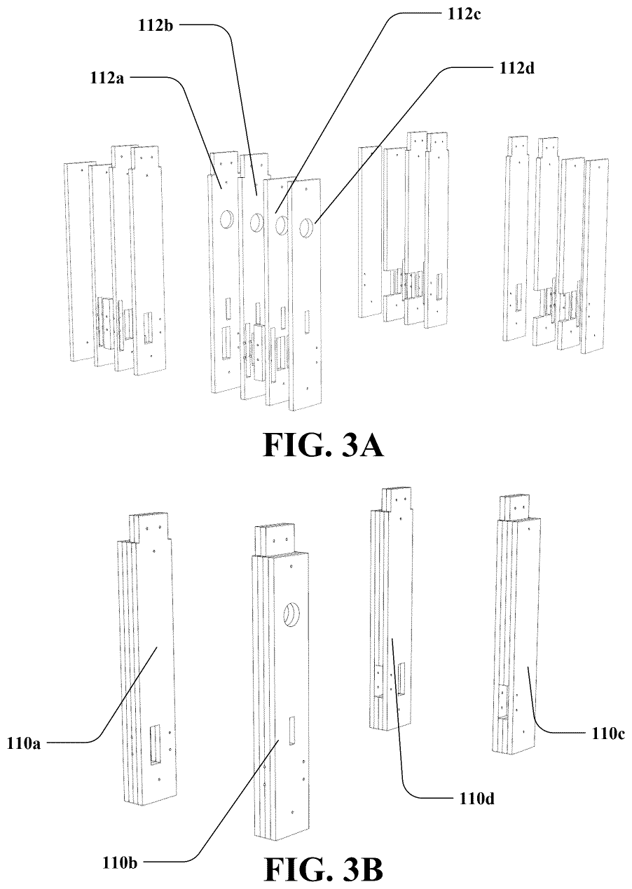

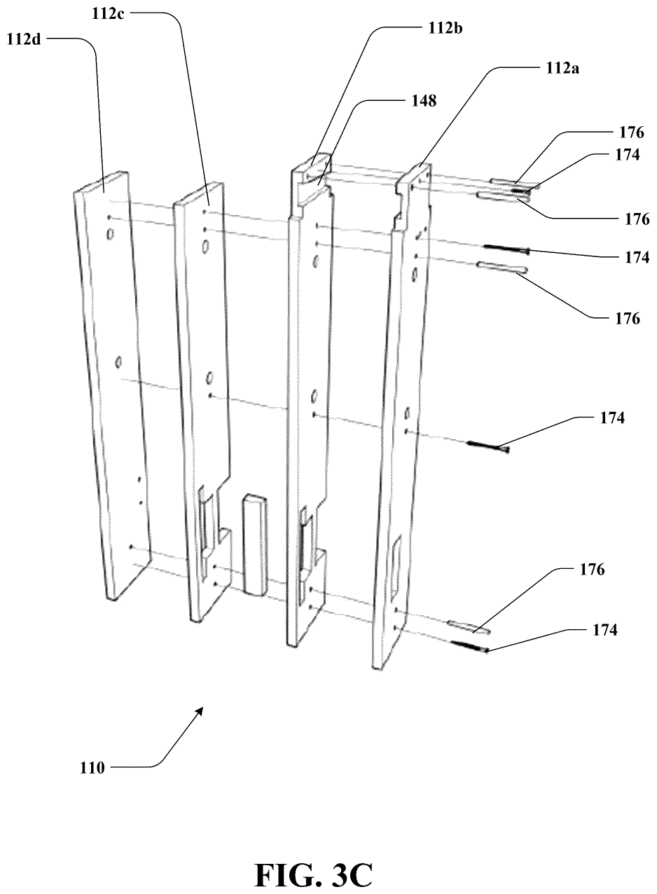

Turning now to FIGS. 3A-3C, the legs 110 will be described. Each leg 110 includes a plurality of leg pieces 112, such as four leg pieces 112a-112d, which may be coupled or laminated together to form each leg 110 of the workbench 100. The legs 110 may be formed with various slots allowing for the receipt of connector pieces and attachments, such as a vice, and for receiving projections of the supports 120. The legs 110 may be constructed with registration/alignment pins 176 placed in pre-drilled holes and construction screws 174 placed in pre-drilled holes. The legs 110 may each include at least two pieces having a projection for receipt into corresponding slots in the top pieces, and at least two pieces that define ledges for supporting the top pieces. For example, leg pieces 112a and 112b may have projections for receipt in slots in the top 130, and leg pieces 112c and 112d define ledges for support the top 130. The leg pieces may be adhered by a suitable adhesive to one another, and pressed together with screws inserted into predrilled holes that create pressure to create a strong bond, and then the screws may be removed.

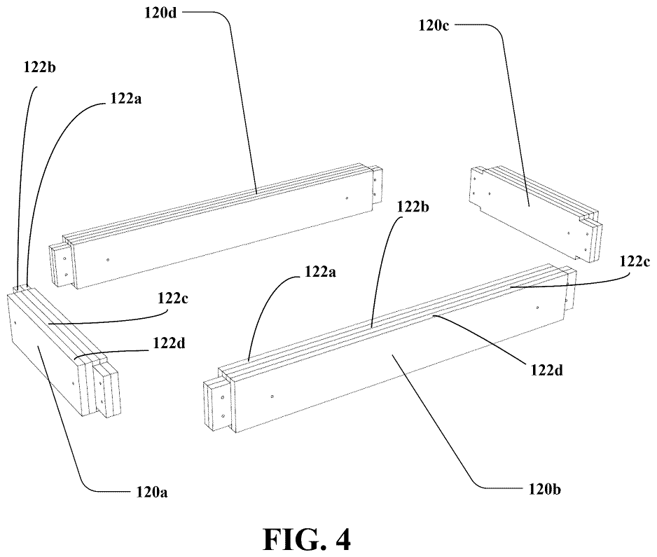

Turning now to FIG. 4, the support 120 will be described. Each support 120 includes a plurality of support pieces 122, such as four support pieces 122a-122d, which may be coupled together or laminated together to form each support 120 for the legs 110. The supports 120 may be of varying lengths depending on the dimension of the assembly 100. For example, the supports 120b and 12d may be longer extending along the front and back of the assembly than supports 120a and 120c extending along the sides of the assembly. The supports 120 may each include at least two pieces having projection for receipt into corresponding slots in the legs 110, and at least two pieces that abut an outer surface of the legs 110. For example, supports 120a and 120c may have support pieces 122a and 122b having projections for receipt in corresponding slots in the legs 110, and support pieces 122c and 122d abut an outer surface of the legs 110, and supports 120b and 120d may have support pieces 122b and 122c having projections for receipt in corresponding slots in the legs 110, and support pieces 122a and 122d abut an outer surface of the legs 110. The support pieces may be adhered by a suitable adhesive to one another, and pressed together with screws inserted into predrilled holes that create pressure to create a strong bond, and then the screws may be removed.

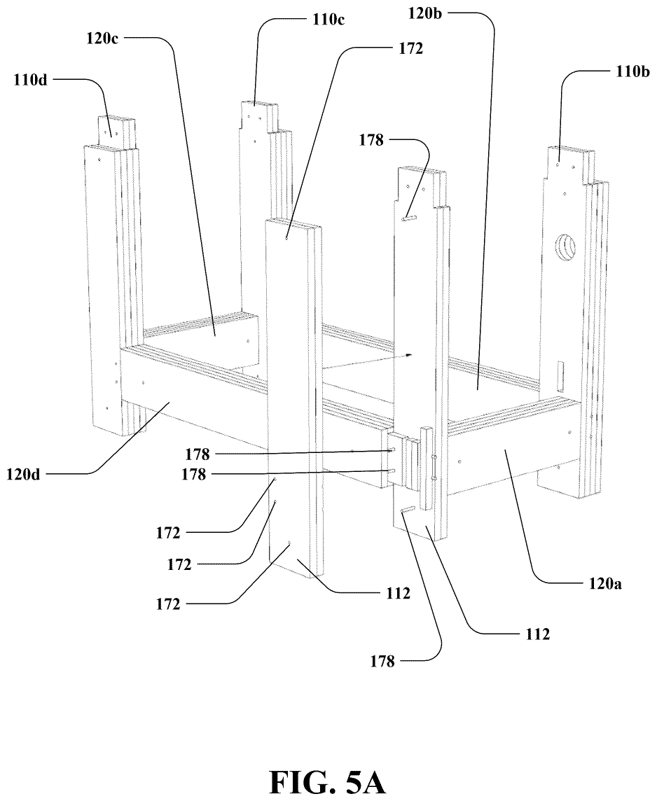

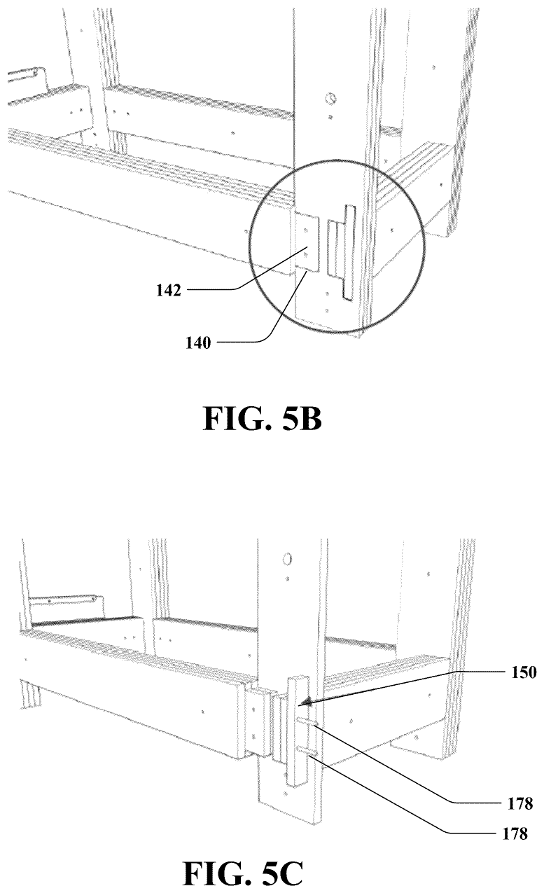

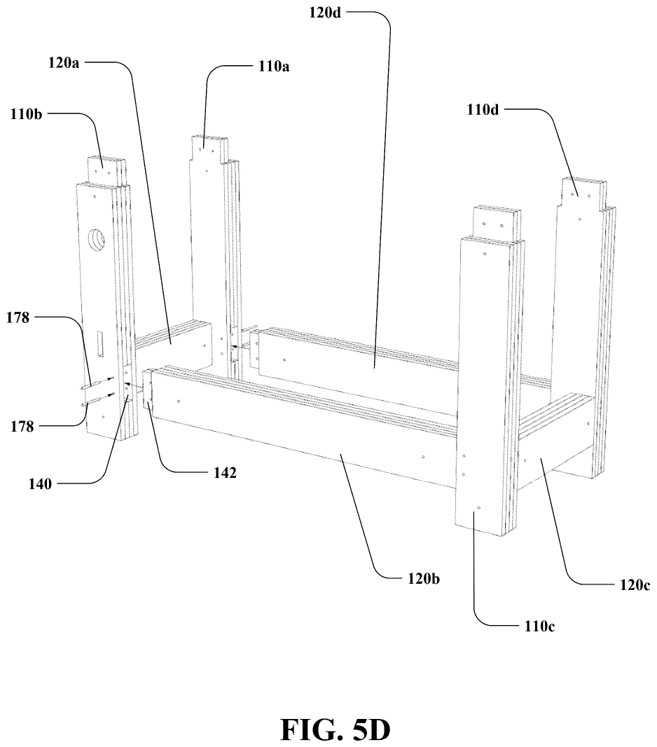

As shown in FIGS. 5A-5D, the legs 110 and supports 120 are connected at joints with mortise-and-tenon joinery. The CNC-cut leg pieces 112a-112d and support pieces 122a-122d are pre-cut with holes 172. The holes 172 on each leg piece 112 and support piece 122 respectively, are slightly misaligned when constructing the legs 110 and supports 120. The joints are fitted together with a mortise 140 and a tenon 142 connection, where the mortises 140 are formed in the legs 110 and the tenons 142 are formed by the projections of the support pieces 122. The joints are secured with a drawboring method. A peg 178 or the like, such as a hardwood peg, is inserted in the misaligned pre-cut holes 172 of the legs 110 and supports 120 to draw or secure the joint together. The pegs 178 may be inserted on the face-side of each piece.

As shown in FIG. 5C, a reinforcement block 150 is embedded in each leg 110 in a pocket formed by the leg pieces. The reinforcement block 150 may be face-grain plywood. The reinforcement block 150 bears the force of the drawbore in side-grain plywood allowing for drawboring on an edge side of plywood. The furniture assembly 100 is constructed by adhering the joints, for example with adhesive. The furniture assembly 100 offers a clamp-free construction, where the registration/alignment pins 176 may be placed in pre-drilled registration holes to prevent lateral slip during adhering. Additionally, the screws 174 may be placed in pre-drilled holes to provide temporary clamping pressure across laminated layers, and after cure, the screws 174 may be removed, leaving no buried hardware.

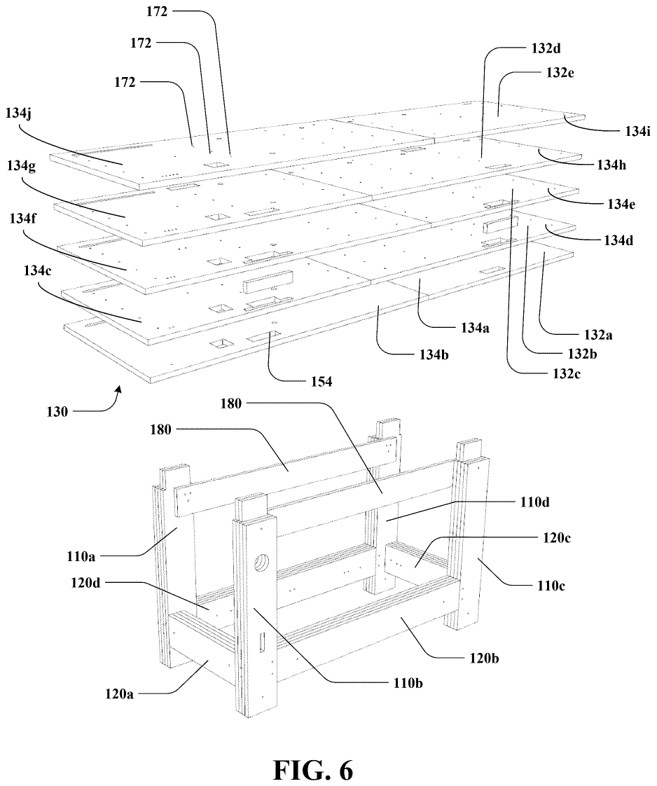

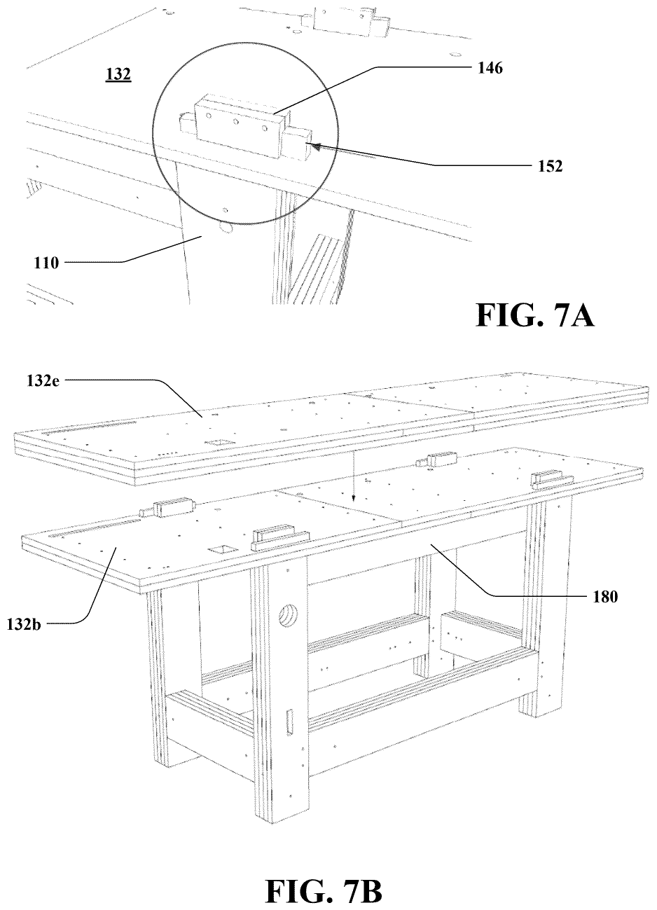

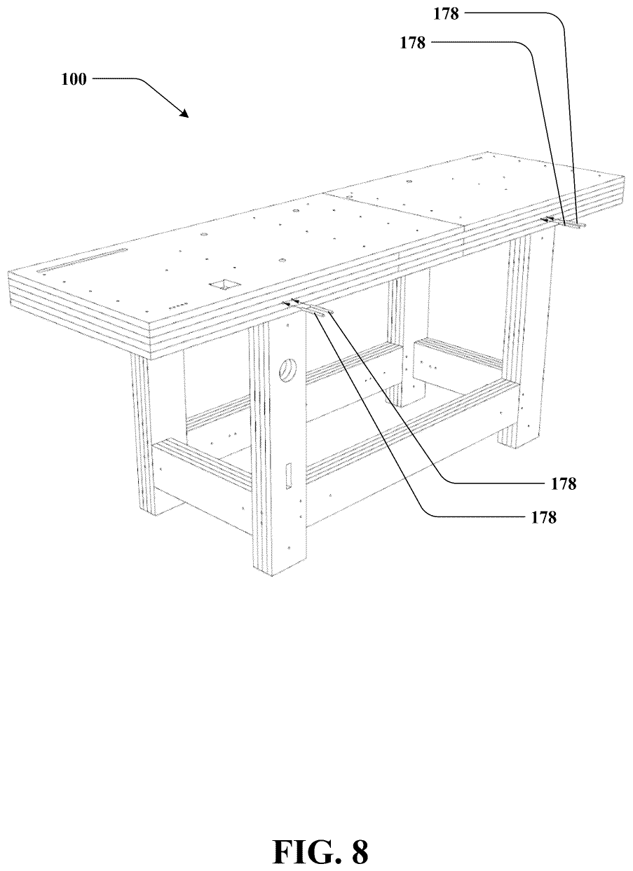

Turning now to FIGS. 6-8, the top 130 will be described. The top 130 includes a plurality of top pieces 132 that may be coupled together to form the top 130 of the workbench 100. For example, the top 130 may be formed by a plurality of layers of material, such as five top layers 132a-132e, where each layer is formed by two or more pieces of differing lengths that are offset from pieces in other layers providing strength to the top 130 and that have ends abutting one another. The top 130 may be formed with various slots allowing for the receipt of connector pieces and for receiving projections of the legs 110. The top 130 also includes a plurality of pre-cut holes 172, that may be misaligned, for receiving pegs 178 for drawing components together simulating pressure of a clamp. For example, a first layer 132a of the top 130 may be formed from a first top piece 134a having a first length and a second top piece 134b having a second length greater than the first length. A second layer 132b of the top 130 may be formed from a third top piece 134c having a third length and a fourth top piece 134d having a fourth length greater than the third length. A third layer 132c of the top 130 may be formed from a fifth top piece 134e having a fifth length and a sixth top piece 134f having a sixth length greater than the fifth length. A fourth layer 132d of the top 130 may be formed from a seventh top piece 134g having a seventh length and an eighth top piece 134h having an eighth length greater than the seventh length. A fifth layer 132e of the top 130 may be formed from a nineth top piece 134i having a ninth length and a tenth top piece 134j having a tenth length greater than the ninth length. In an implementation, the first, third, fifth, seventh, and ninth lengths may be the same or substantially the same and the second, fourth, sixth, eighth, and tenth lengths may be the same or substantially the same.

The combined pieces of each component, the legs 110, the supports 120, and the top 130, are constructed with the tenons and mortises that connect the together. For example, the upper portion of each leg 110, which forms a tenon 146, incorporates a mortise 148 (FIG. 3C) and a wedge tenon 152 is driven into the mortise 148 to pull the first layer of the top 130 tightly against the legs 130. Once remaining layers 132b-132e of the top 130 are added, the mortise-and-tenon assembly including the tenon 146 formed by upper portion of each leg 110 is received in the mortise 154 formed by the layers and housed within the remaining layers 132 and thus hidden in the top 130.

The top 130 may be assembled without a separate work surface by using build-in-place strips 180. The strips 180 are attached to the legs 110 after the frame is assembled to provide parallel, co-planar platforms for layering the top 130. After adhesive cure and any temporary fasteners are removed, the build-in-place strips 180 may be knocked out, leaving a flat top 130 that does not require separate installation. The assembly is performed by adhering tenons to mortises with adhesive and using pegs 178 driven through offset holes 172 to draw joints together. Registration pins 176 and/or temporary screws 174 ensure layer alignment and clamping pressure during cure. After cure, screws 174 are removed, and the bench 100 includes no buried hardware, allowing drilling or cutting to modify the bench without risk of damaging concealed fasteners.

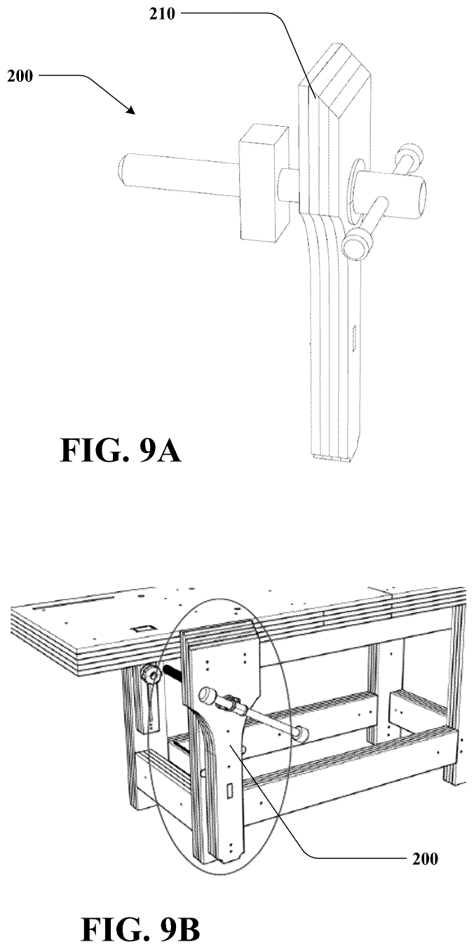

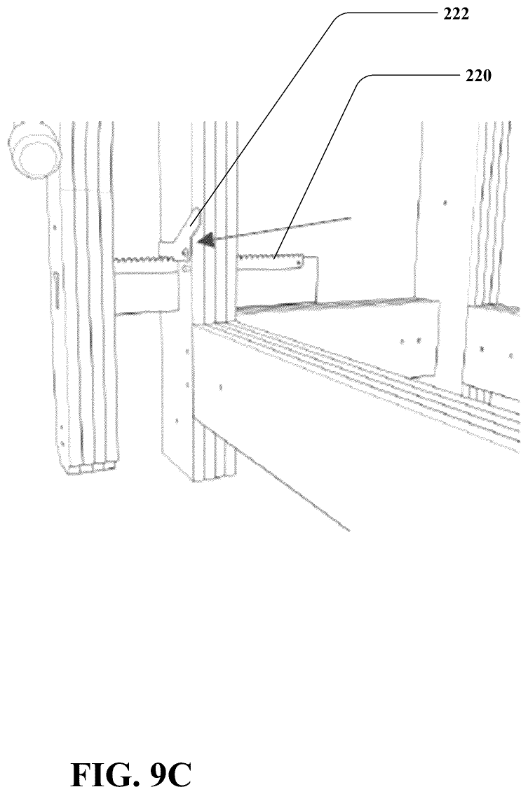

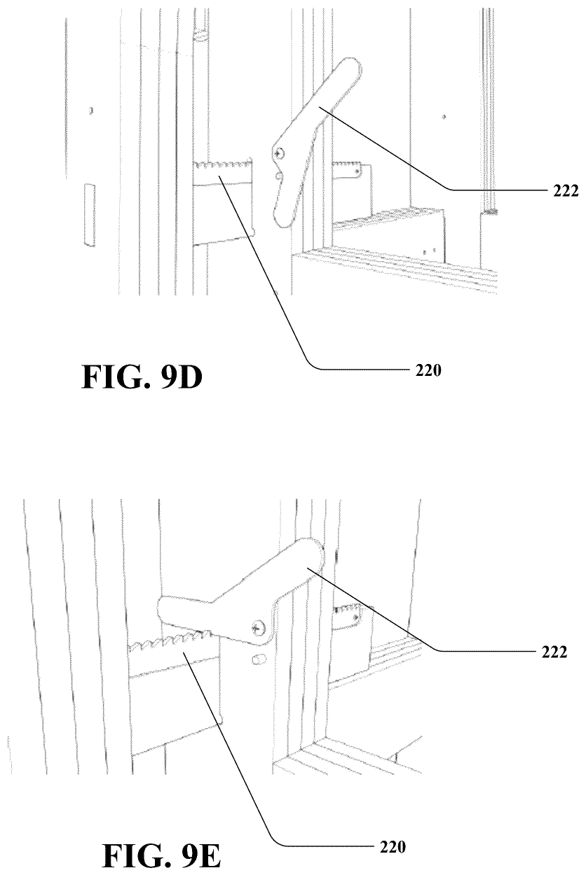

Turning to FIGS. 9A-9E, an integrated workholding appliance may be provided, such as a leg vice 200 constructed from laminated plywood, for example as discussed above. The vice 200 employs a steel ratchet 220 and lever 222. The lever is held into the ratchet teeth by gravity and as the vise is opened, the ratchet auto-adjusts to the new setting. To close the vise to a smaller setting, the user flips the lever 222 out of the way, adjusts the vise and flips the lever 222 back into position. The lever is positioned to be moved back and forth with either the user's hand or foot.

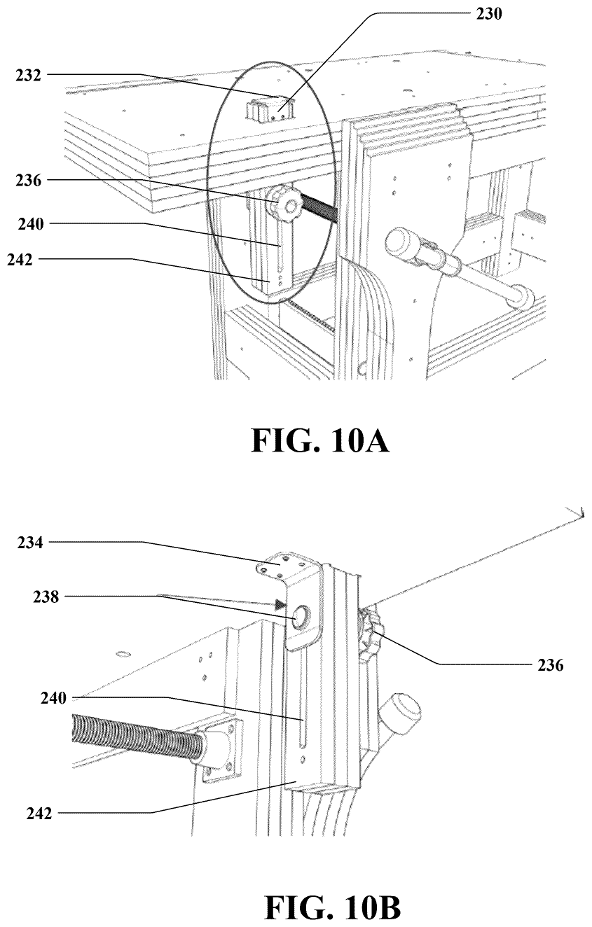

Turning to FIGS. 10A and 10B, a planing stop assembly 230 may also be included in the furniture assembly 100. The stop assembly 230 includes a planning stop 232, which may be a laser-cut and bent piece of stainless steel, a bracket 234, a bolt 238 through a central slot 240 in a post 242, and a tension knob 236 to set and hold height. The user may loosen the knob 236 to raise or lower the stop 230 precisely, or set the knob 236 for medium tension and adjust the post 232 with light mallet taps.

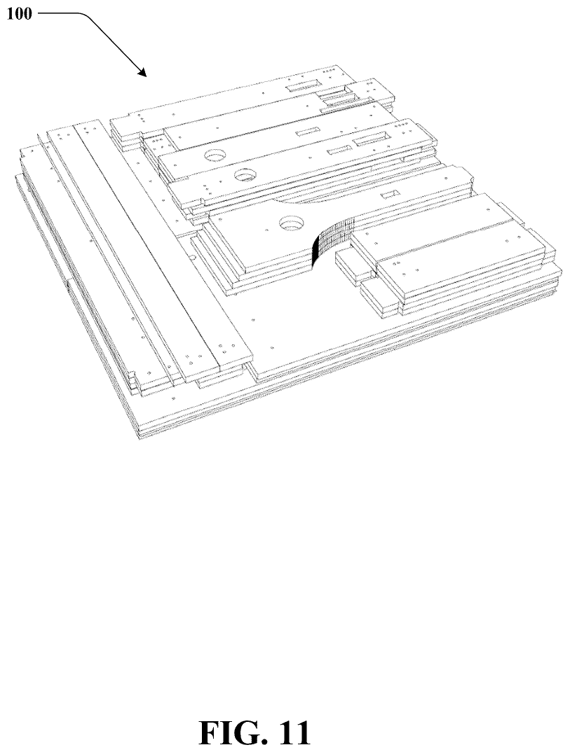

FIG. 11 illustrates the furniture assembly 100 in a shipped state, for example in a state to be placed on a pallet. The furniture assembly 100 minimizes wasted space and uses little packaging. A further feature is that the top 130 is made of overlapping layers of plywood. This construction allows for larger finished assemblies to be packed on smaller pallets, for example by allowing a seven-foot-long furniture assembly 100 to be packed on a four-foot square shipping pallet 300, further reducing shipping costs.

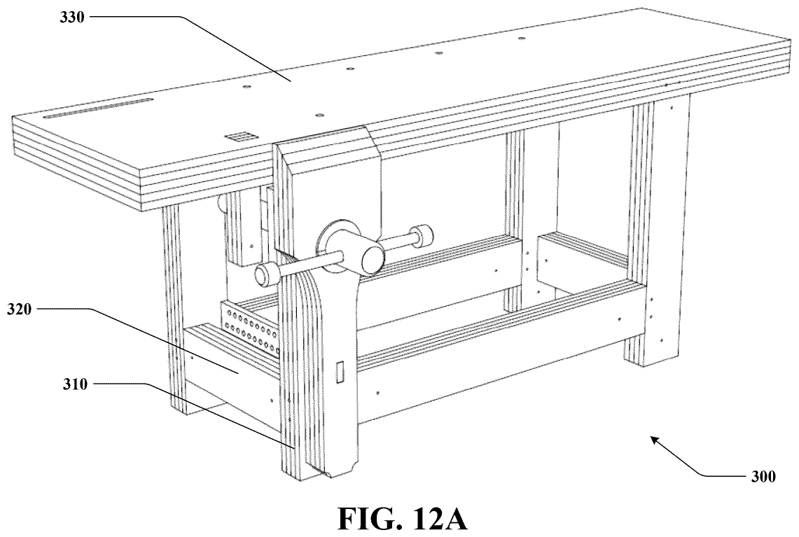

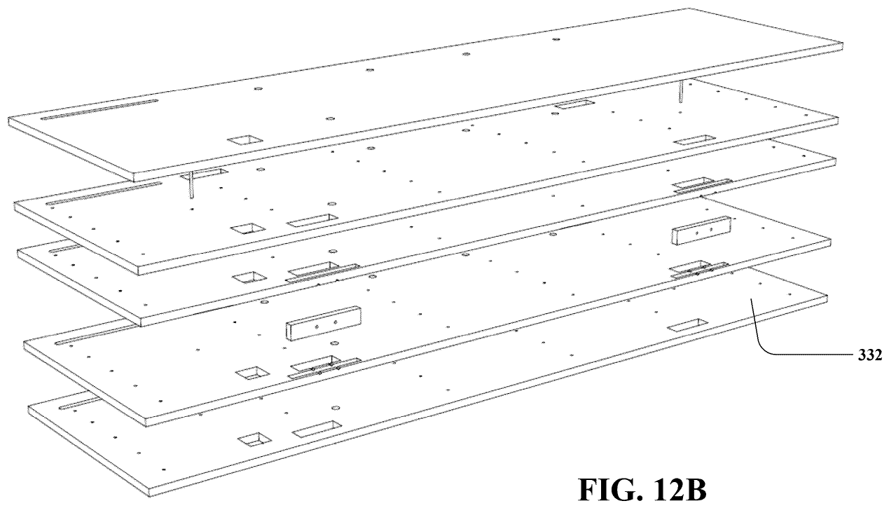

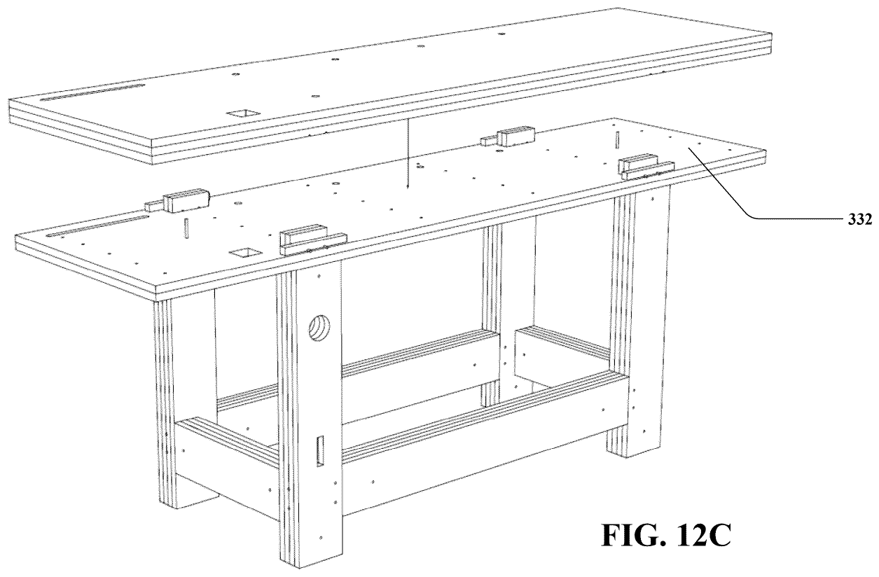

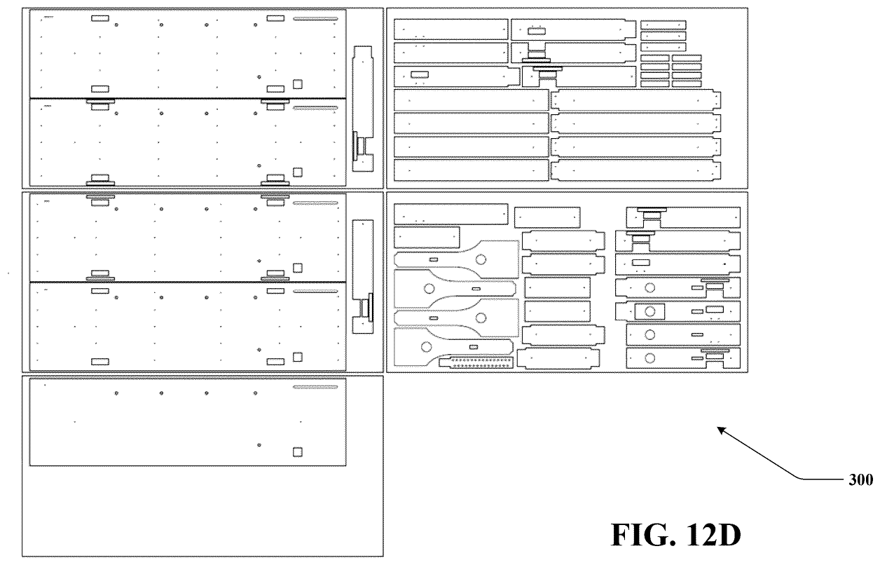

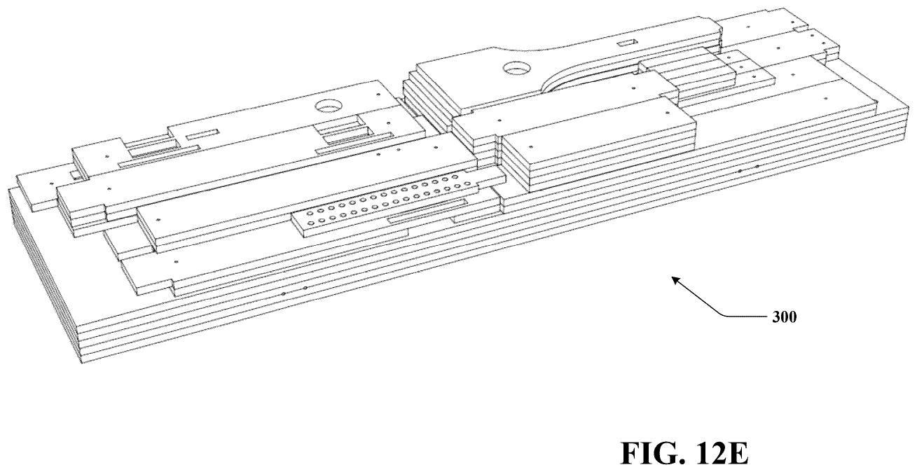

Turning now to FIGS. 12A-12, an exemplary embodiment of the furniture assembly is shown at 300. The furniture assembly 300 is substantially the same as the above-referenced furniture assembly 100, and consequently the same reference numerals but indexed by 200 are used to denote structures corresponding to similar structures in the furniture assemblies. In addition, the foregoing description of the furniture assembly 100 is equally applicable to the furniture assembly 300 except as noted below.

The top 330 may include a plurality of top pieces 332 that may be coupled together to form the top 330 of the workbench 300. Each top piece 332 may be a single piece rather than multiple pieces, where the flat pack arrangement may accommodate the larger single pieces of the top 330.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A furniture assembly comprising:
a plurality of legs;
a plurality of supports each configured to be coupled to at least two of the plurality of legs;
and a top configured to be coupled to the plurality of legs,
wherein each of the legs, the supports, and the top are formed from a plurality of pieces coupled together.

2. The furniture assembly of claim 1, wherein at least one of the plurality of supports is coupled to at least one of the plurality of legs at a mortise-and-tenon joint.

3. The furniture assembly of claim 2, wherein the mortise-and-tenon joint is held by a peg extending through a plurality of pre-formed holes that are offset to draw the joint together when the peg is driven through the holes.

4. The furniture assembly of claim 3, wherein at least one of the plurality of legs includes a reinforcement block embedded within a pocket of the leg to bear a force produced by the peg driven through the offset holes.

5. The furniture assembly of claim 1, wherein the top comprises a plurality of stacked layers of top pieces coupled together.

6. The furniture assembly of claim 5, wherein each layer includes two top pieces having ends that abut one another forming a seam, wherein the seam of each layer is offset relative to the of an adjacent layer.

7. The furniture assembly of claim 5, wherein each layer of the plurality of stacked layers is a single piece.

8. The furniture assembly of claim 5, wherein an upper portion of at least one of the plurality of legs forms a tenon that is received within a mortise formed by the stacked layers of the top pieces.

9. The furniture assembly off claim 8, wherein a wedge tenon is configured to be driven into the mortise to pull a first stacked layer of the top against the legs and is enclosed within the top by subsequent stacked layers.

10. The furniture assembly of claim 1, wherein at least one of the plurality of legs, the plurality of supports, or the top includes pre-formed holes configured to receive temporary screws arranged to hold the plurality of pieces during adhesive cure, and wherein the temporary screws are removable after cure.

11. A method of forming a furniture assembly, the method comprising:
cutting or perforating a sheet material to form a plurality of leg pieces, a plurality of support pieces, and a plurality of top pieces;
forming a plurality of legs by laminating at least two of the plurality of leg pieces together for each leg;
forming a plurality of supports by laminating at least two of the plurality of the support pieces together for each support;
forming a top by laminating the plurality of top pieces together; and
assembling the plurality of legs, plurality of supports, and the top together.

12. The method of claim 11, wherein assembling includes interconnecting at least one of the plurality of supports to at least two of the plurality of legs at a mortise-and-tenon joint.

13. The method of claim 11, wherein cutting or perforating the sheet material comprises computer numerically controlled cutting or perforating of cabinet-grade plywood.

14. The method of claim 11, further comprising inserting alignment pins into registration holes in the pieces during lamination.

15. The method of claim 11, further comprising driving temporary screws through pre-formed holes to hold pressure across laminated pieces during adhesive cure and removing the temporary screws after cure for a clamp-free assembly.

16. The method of claim 11, further comprising driving a wedge tenon at an upper portion of at least one of the plurality of legs to secure a first layer of the top against the legs.

17. The method of claim 16, further comprising enclosing the wedge tenon within subsequent adjacent layers of the top.

18. A flat-pack kit for constructing a workbench, the kit comprising:
a plurality of leg pieces;
a plurality of support pieces;
a plurality of top pieces; and
a plurality of pegs,
wherein each of the plurality of leg pieces, plurality of support pieces, and plurality of top pieces are cut from a sheet material and configured to be laminated to form, respectively, a plurality of legs, a plurality of supports, and a top,
wherein the at least some of the plurality of support pieces include projections configured to form tenons receivable in mortises formed in the legs, and
wherein the plurality of pegs are configured to be driven through offset holes in the legs and the supports to draw mortise-and-tenon joints together.

19. The flat-pack kit of claim 18, wherein at least one of the leg pieces defines a pocket configured to receive a reinforcement block to bear a drawboring load produced by the pegs driven through offset holes.

20. The flat-pack kit of claim 18, further comprising components of a workholding appliance including at least one of a leg vise having laminated jaws or a planing stop assembly including a stop, a bracket, a post having a slot, a bolt extending through the slot, and a tension knob configured to set and hold a height of the stop.
